(19) United States
(12) Patent Application Publication
(10) Pub. No.: US 2015/0330795 A1
(43) Pub. Date: Nov. 19, 2015

(54) Method to Dynamically Adjust Assistance Data for Improved Indoor Positioning Performance

(71) Applicant: QUALCOMM INCORPORATED, San Diego, CA (US)

(72) Inventors: Ramya SRINIVASAN, Campbell, CA (US); Milind H. PATIL, Santa Clara, CA (US); Ferit O. AKGUL, San Jose, CA (US); Praveen DUA, Cupertino, CA (US); Gaurav LAMBA, Los Altos, CA (US)

(73) Assignee: QUALCOMM INCORPORATED, San Diego, CA (US)

(21) Appl. No.: 14/278,931

(22) Filed: May 15, 2014

(51) Int. Cl. G01C 21/20

(52) U.S. Cl. CPC G01C 21/206

(57) ABSTRACT

Methods and systems are presented for updating assistance data in an indoor navigation system. In some embodiments, a method includes receiving ranging measurements from a reference positioning terminal, computing an estimated location of the reference positioning terminal based on the received ranging measurements, receiving information associated with a high-confidence location of the reference positioning terminal, determining that a difference between the estimated location and the high-confidence location of the reference positioning terminal is greater than a predetermined threshold, and sending an assistance data update to a server associated with the indoor navigation system, the assistance data update including an update to assistance data based on the received ranging measurements of the reference positioning terminal.

### BACKGROUND

The present disclosures generally relate to updating assistance data in an indoor navigation system.

Accurate positioning of client devices, e.g. mobile phones, tablets, etc., using indoor navigation techniques may rely on key information associated with the building or venue the client device currently resides in. This information may include the locations of the APs, the layout of the building or floor, including positions of the walls, doors, physical materials of the walls, etc., and heatmap data of the APs expressing signal map characteristics of the APs, including received signal strength indicator (RSSI) information and/or round trip time (RTT) information. This information may collectively be referred to as assistance data (AD) of the indoor navigation system. Problems may arise however, when the layout of the building or floor changes, requiring the AD to be updated. Currently, updating the AD for indoor navigation systems is at least partially a manual process, and thus updating the AD may involve a tedious, time-consuming and potentially error-prone process if performed manually.

Thus, new methods for updating assistance data of an indoor navigation system are desirable.

### BRIEF SUMMARY

Methods and systems are presented for dynamically updating assistance data in indoor navigation systems automatically or without human intervention. Assistance data may be automatically updated using a feedback approach involving at least one device or terminal with a known reference position. An estimated location of the reference terminal may be determined based on received ranging measurements. The reference terminal, having the capability of determining its own position independent of the indoor positioning system, also sends its actual location, or at the least, a location representing an approximate measurement of its actual location, which may be referred to as a “high-confidence location.” A difference between the estimated location using the ranging measurements, and the high-confidence location reported by the reference terminal, may then be computed. If the difference exceeds a predetermined threshold, then it may be concluded that the AD used to estimate the reference terminal's position needs to be updated.

In some embodiments, a method for updating assistance data in an indoor navigation system is presented. The method may include: receiving ranging measurements from a reference positioning terminal; computing an estimated location of the reference positioning terminal based on the received ranging measurements; receiving information associated with a high-confidence location of the reference positioning terminal; determining that a difference between the estimated location and the high-confidence location of the reference positioning terminal is greater than a predetermined threshold; and sending an assistance data update to a server associated with the indoor navigation system, the assistance data update including an update to assistance data based on the received ranging measurements of the reference positioning terminal.

In some embodiments, the ranging measurements include RSSI and/or RTT measurements.

In some embodiments, the reference positioning terminal includes a mobile device with a known ground truth.

In some embodiments, the ranging measurements are received at a first access point associated with the indoor navigation system.

In some embodiments, the reference positioning terminal includes a second access point associated with the indoor navigation system.

In some embodiments, the assistance data update includes an update to a localized portion of the assistance data associated with the first access point.

In some embodiments, the assistance data includes locations of access points, information associated with a physical layout of a building, and heatmap data associated with timing information of the access points.

In some embodiments, the ranging measurements include signals at a 2.4 GHz frequency.

In some embodiments, the ranging measurements include signals at a 5 GHz frequency.

In some embodiments, the ranging measurements include signals within a frequency range of 3-10 GHz.

In some embodiments, the ranging measurements include signals from a single antenna from the reference positioning terminal.

In some embodiments, the ranging measurements include signals from a plurality of antennas from the reference positioning terminal. In some embodiments, the plurality of antennas includes dual antennas. In some embodiments, the plurality of antennas includes a configuration of 4×4 antennas.

In some embodiments, the information associated with the high-confidence location includes information associated with a location of the reference positioning terminal.

In some embodiments, an access point is presented. The access point may include a wireless transceiver configured to receive ranging measurements from a reference positioning terminal, and receive information associated with a high-confidence location of the reference positioning terminal. The access point may also include a processor. The processor may be configured to: compute an estimated location of the reference positioning terminal based on the received ranging measurements, and compute a difference between the estimated location and the high-confidence location of the reference positioning terminal. The wireless transceiver may be configured to send an assistance data update to a server associated with an indoor navigation system, the assistance data update including an update to assistance data based on the received ranging measurements of the reference positioning terminal.

In some embodiments, a system for updating assistance data in an indoor navigation system is presented. The system may include: means for receiving ranging measurements from a reference positioning terminal; means for computing an estimated location of the reference positioning terminal based on the received ranging measurements; means for receiving information associated with a high-confidence location of the reference positioning terminal; means for computing a difference between the estimated location and the high-confidence location of the reference positioning terminal; and means for sending an assistance data update to a server associated with the indoor navigation system, the assistance data update including an update to the assistance data based on the received ranging measurements.

In some embodiments, a non-transitory processor-readable medium is presented. The non-transitory processor-readable medium may include processor-readable instructions configured to cause a processor to update assistance data in an indoor navigation system, comprising: code to receive ranging measurements from a reference positioning terminal; code to receive information associated with a high-confidence location of the reference positioning terminal; code to compute an estimated location of the reference positioning terminal based on the received ranging measurements; code compute a difference between the estimated location and the high-confidence location of the reference positioning terminal; and code to send an assistance data update to a server associated with the indoor navigation system, the assistance data update including an update to the assistance data based on the received ranging measurements of the reference positioning terminal.

### BRIEF DESCRIPTION OF THE DRAWINGS

An understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is an example access point for implementing some aspects of the present disclosures.

FIG. 2 is an example mobile device for implementing some aspects of the present disclosures.

FIG. 3 illustrates an example process flow of conventional techniques for updating assistance data of an indoor navigation system.

FIG. 4 illustrates an example process flow for updating assistance data of an indoor navigation system according to some embodiments.

FIGS. 5A, 5B, 5C, and 5D illustrate example scenarios for updating assistance data utilizing various techniques of the present disclosures.

FIGS. 6A and 6B illustrate another example scenario for updating assistance data utilizing various techniques of the present disclosures.

FIGS. 7A and 7B illustrate example ranging measurements according to some embodiments.

FIG. 8 illustrates an example method according to some embodiments.

FIG. 9 illustrates an example computer system according to some embodiments.

### DETAILED DESCRIPTION

Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure or the spirit of the appended claims.

Methods and systems are presented for dynamically updating assistance data in indoor navigation systems automatically or without human intervention. Indoor positioning navigation systems of a building or floor tend to utilize access points (APs) located throughout the building or floor to perform indoor positioning techniques. Accurate positioning of client devices, e.g. mobile phones, tablets, etc., may rely on key information associated with the building. This information may include the locations of the APs, the layout of the building or floor, including positions of the walls, doors, physical materials of the walls, etc., and heatmap data of the APs expressing signal map characteristics of the APs, including received signal strength indicator (RSSI) information and/or round trip time (RTT) information. This information may collectively be referred to as assistance data (AD) of the indoor navigation system. The client device will be able to accurately determine its position within the building or floor by sending real-time ranging measurements to the APs in combination with knowledge of accurate assistance data.

Problems may arise however, when the layout of the building or floor changes, requiring the AD to be updated. For example, a museum may periodically change parts of its layout when a new exhibit is introduced. As another example, part of a floor of an office building may be remodeled or reconfigured when a new tenant moves in. If the locations of the APs are moved and/or the walls are reconfigured, for example, the indoor positioning system may generate inaccurate readings without an update to the AD. Currently, updating the AD for indoor navigation systems is at least partially a manual process. A surveyor may need to manually gather ranging measurements by roaming around the building. In other cases, the AD regarding the layout of the floor plan and the locations of the APs may need to be manually updated.

By implementing aspects of the disclosure, however, assistance data may be automatically updated using a feedback approach involving at least one device or terminal with a known reference position. This device, referred to herein as a reference positioning terminal, may be in some cases a mobile device of a customer or patron with the capability to determine its position independent of the indoor navigation system, i.e. the “ground truth” of the reference positioning terminal is known. For example, the mobile device may possess an accurate GPS engine. As another example, the mobile device may include inertial sensors or other sensors capable of determining the mobile device's location. In other cases, the reference positioning terminal may include an AP of the indoor navigation system itself, whose location is known to have not moved.

Methods for updating the AD of the indoor navigation system may include first receiving at an access point ranging measurements, e.g. RSSI or RTT measurements, from the reference positioning terminal. Generally, ranging measurements may refer to any measurements quantifying a distance between the reference positioning terminal and the access point, and may include RSSI or RTT measurements, angle-of-arrival measurements if the reference positioning terminal is equipped with multi antenna arrays, or other fingerprinting methods or sensor data known to estimate a distance to the access point. In some cases, multiple APs of the indoor navigation system receive ranging measurements from the reference terminal. An estimated location of the reference terminal may be determined based on the received ranging measurements. The reference terminal, having the capability of determining its own position independent of the indoor positioning system, also sends its actual location, or at the least, a location representing an approximate measurement of its actual location, which may be referred to as a “high-confidence location.” A difference between the estimated location using the ranging measurements, and the high-confidence location reported by the reference terminal, may then be computed. If the difference exceeds a predetermined threshold, e.g. 3 meters, 5 meters, etc., then it may be concluded that the AD used to estimate the reference terminal's position needs to be updated. The AD may then be updated using the ranging measurements received from the reference terminal. These concepts and related embodiments will be discussed in more detail, below.

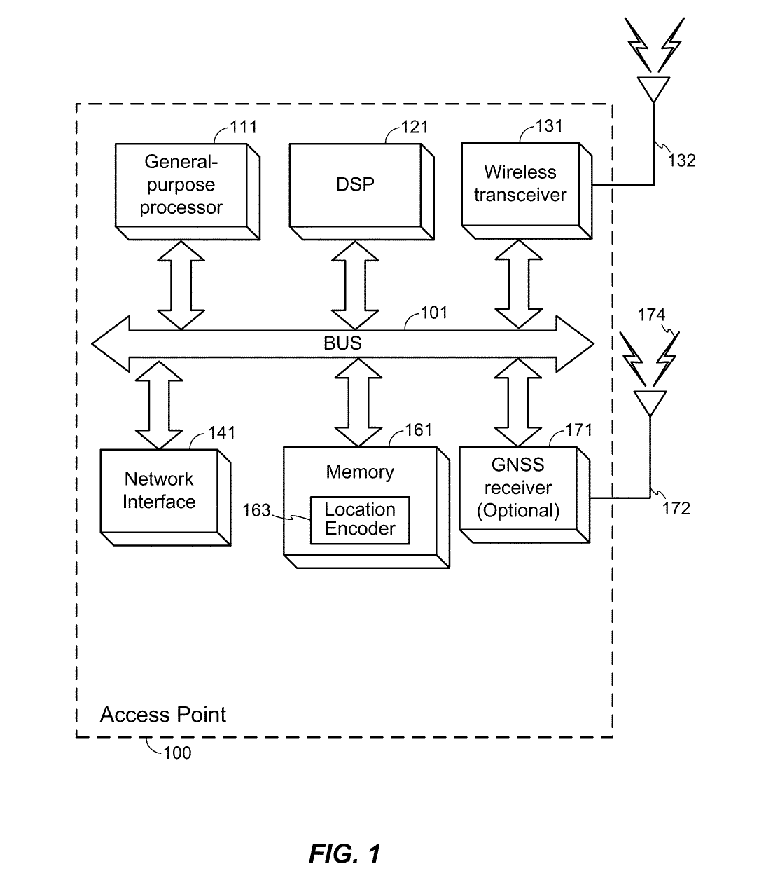

Referring to FIG. 1, an example access point (AP) 100 used to implement some aspects of the present disclosures is illustrated. Here, AP 100 may include a general-purpose processor(s) 111, memory 161, DSP(s) 121, a wireless transceiver 131, a bus 101, antennas 132 and 172, and in some cases a GNSS receiver 171. In some embodiments, antennas 132 and 172 may be the same antenna. Furthermore, in addition to the wireless transceiver 131, AP 100 can further include a network interface 141 to communicate with a network (e.g., indoor navigation network, a network of a preferred carrier, Internet, etc.). Memory 161 may also contain a location encoder 163 that may be configured to encode information pertaining to the location of AP 100 and/or store the location of a previously encoded location of an AP. AP 100 may be referred to as a Home NodeB (HNB) or Home eNode B (HeNB). Example APs 100 may include access points (e.g. WiFi access points), femto cells, base stations, picocells, macrocells, Bluetooth™ transceiver, Zigbee™ transceiver or other suitable AP type.

In some embodiments, AP 100 may be equipped with multiple antenna groups, not shown. The multiple antennas may facilitate communication with multiple mobile devices, such as mobile device 200, discussed more below.

In some embodiments, the wireless transceiver 131 may be configured to receive ranging measurements from a reference positioning terminal. For example, the ranging measurements may include measurements quantifying a distance between the reference positioning terminal and the access point, such as RSSI or RTT measurements, angle-of-arrival measurements if the reference positioning terminal is equipped with multi antenna arrays, and/or other fingerprinting methods or sensor data known to estimate a distance to the access point. In some embodiments, the wireless transceiver 131 may be further configured to receive information associated with a high-confidence location of the reference positioning terminal. For example, the reference positioning terminal may have the capability of determining its own position independent of the indoor positioning system. The wireless transceiver 131 may receive the actual location of the reference positioning terminal, or at the least, the high-confidence location of the reference positioning terminal (e.g., a location representing an approximate measurement of the actual location of the reference positioning terminal).

In some embodiments, the processor 111 may be configured to compute an estimated location of the reference positioning terminal based on the received ranging measurements. The processor 111 may also determine that a difference between the estimated location and the high-confidence location of the reference positioning terminal is greater than a predetermined threshold. For example, if the difference exceeds a predetermined threshold, e.g. 3 meters, 5 meters, or the like, the processor 111 may determine that the assistance data used to estimate the reference terminal's position needs to be updated. The wireless transceiver 131 may send an assistance data update to a server associated with an indoor navigation system. In some embodiments, the assistance data update includes an update to assistance data based on the received ranging measurements of the reference positioning terminal. In some embodiments, the assistance data may then be updated by the server associated with the indoor navigation system using the ranging measurements received from the reference terminal. For example, the assistance data update may instruct the server to update the assistance data. In some embodiments, the assistance data may be updated before sending the assistance update data (e.g., by the access point 100). In such embodiments, the assistance data update may include the actual updated assistance data.

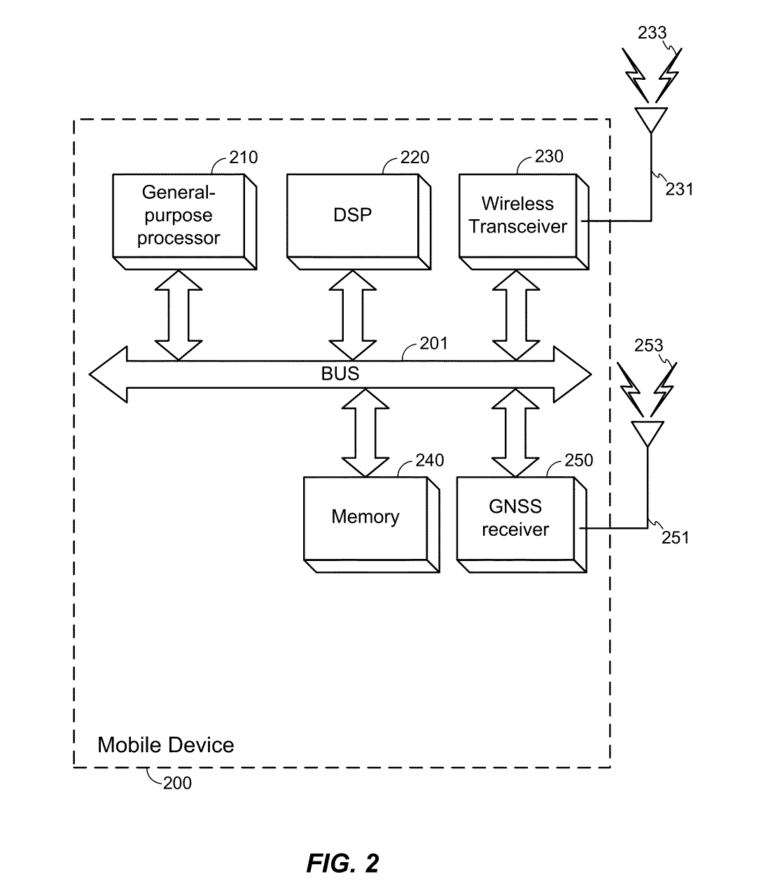

Referring to FIG. 2, an example mobile device 200 used to implement some aspects of the present disclosure is presented. The mobile device 200 may include one or more wireless transceivers 230 connected to the bus 201. The wireless transceiver 230 may be operable to receive a wireless signal 233 via antenna 231. The wireless signal 233 may be transmitted via a wireless network. In some embodiments, the wireless network may be any wireless network such as a wireless LAN (WLAN) such as WiFi, a Personal Access Network (PAN), such as Bluetooth™ or Zigbee™, or a cellular network (e.g. a GSM, WCDMA, LTE, CDMA2000 network). In some embodiments, antennas 231 and 251 may be the same antenna. Wireless transceiver 230 via antenna 231 may be configured to receive various radio frequency (RF) signals 233 from one or more APs. Mobile device 200 may also be equipped with GNSS receiver 250, and may receive GNSS wireless signals 253 via antenna 251. Mobile device 200 may be configured to obtain information about its own location and/or of the locations of the APs, such as AP 100, via wireless transceiver 230 and/or GNSS receiver 250. This information may come in various forms, including ranging information, such as received signal strength indicator (RSSI) measurements, round trip time (RTT) measurements, 2-dimensional or 3-dimensional coordinates, or other types of formats known to those with skill in the art, for APs. Mobile device 200 may be configured to measure multiple sets of ranging information for multiple APs in order to determine the location of mobile device 200. Mobile device 200 may be configured to process the wireless signals 233, in whole or in part, and/or calculate the location of the mobile device 200. In some embodiments, general-purpose processor(s) 210, memory 240, DSP(s) 220, and specialized processors (not shown) may also be utilized to process the GNSS signals 253, in whole or in part, and/or calculate the location of the mobile device 200, in conjunction with GNSS receiver 250. The storage of GNSS or other location signals may be done in memory 240 or other registers (not shown).

In some embodiments, multiple wireless transceivers 230 may be used for location determination and/or communication. For example, in some embodiments, a WAN transceiver, a WLAN transceiver and/or a PAN transceiver, or any combination of the above, may be used for communication and/or location purposes. In some embodiments, multiple transceivers of similar type such as multiple WAN transceivers for the support of multiple air interfaces and/or multiple PAN interfaces such as for the support of both Bluetooth and Zigbee may be used for communication and/or location purposes.

A mobile device 200 can also be called a system, subscriber unit, subscriber station, mobile station, mobile, remote station, remote terminal, user terminal, terminal, mobile terminal, wireless device, wireless terminal, wireless communication device, user agent, user device, Secure User Plane (SUPL) Enabled Terminal (SET) or user equipment (UE). A mobile device can be a cellular telephone, a cordless telephone, a smartphone, a Session Initiation Protocol (SIP) phone, a wireless local loop (WLL) station, a personal digital assistant (PDA), a handheld device having wireless connection capability, a computing device, a laptop, a tablet or other processing device connected to or containing a modem, for example, a wireless modem, or other related devices.

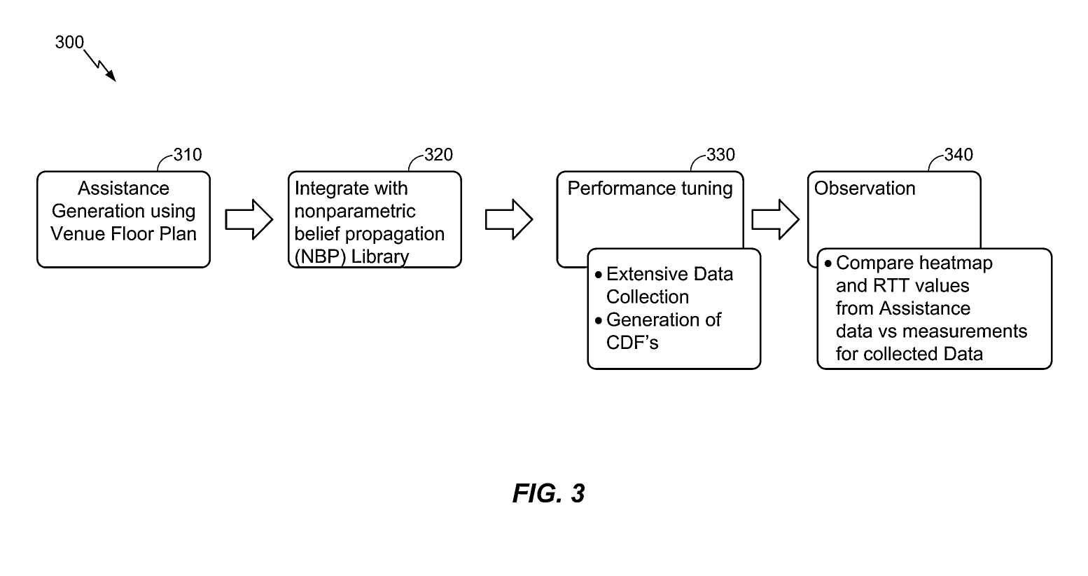

Referring to FIG. 3, flowchart 300 describes example processes for generating and updating assistance data (AD) of an indoor navigation system. Here, starting at block 310, AD may be generated using a floor plan of a venue, such as a blueprint or a map of a floor or building. The process may be performed manually, in that the locations of walls, stairwells, doors, etc., may be manually inputted into an indoor navigation system. Example tools to facilitate this process are shown in FIG. 3.

Next, at block 320, the AD may be integrated with a nonparametric belief propagation (NBP) library, which is a database known in the industry to help facilitate indoor navigation. The process may also be performed manually or using computer programs but initiated manually by an analyst. Several example frameworks are illustrated in FIG. 3 describing how the AD may be integrated with the NBP library.

At block 330, performance tuning of the AD with the NBP library may be performed. The performance tuning may be used to refine the accuracy of the indoor positioning utilizing the assistance data. For example, inaccuracies may still exist when trying to adjust for the presence of walls and other impediments, even with some AD available. To refine the positioning process, extensive data from test mobile devices may need to be used to compare the estimated location of the mobile devices with their actual locations.

At block 340, continued observation to monitor accuracy and overall performance of the indoor navigation system may be required. For example, one or more analysts may compare the heatmap and RTT values from the AD with the measurements obtained by empirical data from test mobile devices. Where there are sufficient discrepancies, additional performance tuning may be required, or the assistance data may need to be reexamined and possibly updated. Analysts may need to physically observe the areas in the building or floor containing the discrepancies, to see if walls or other structures have been moved. Obviously, this process can be very tedious, time consuming, and inefficient.

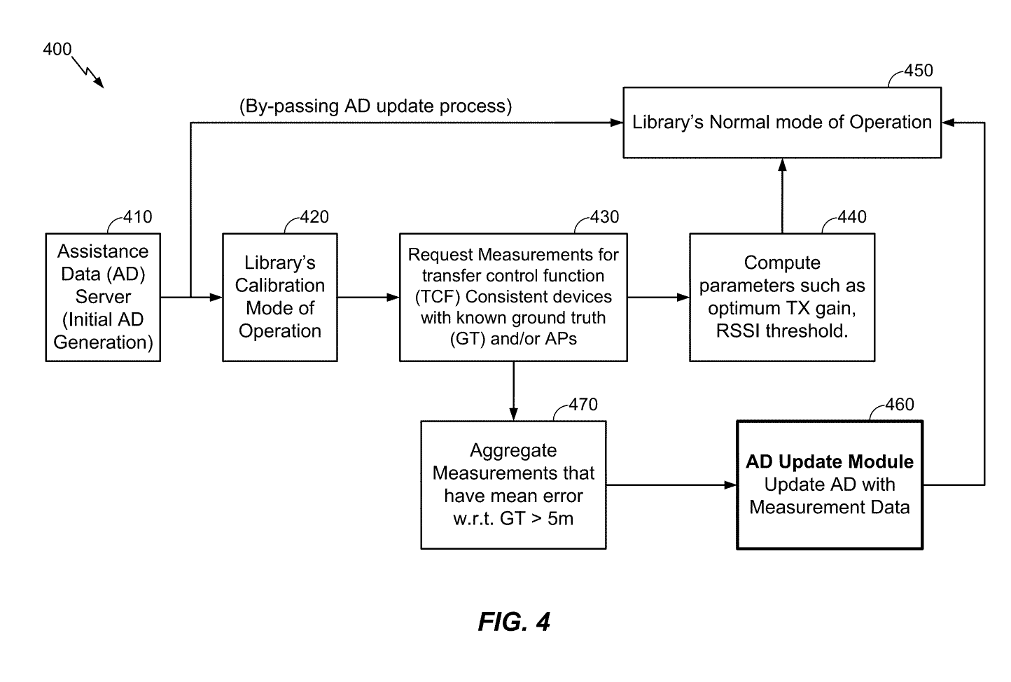

Referring to FIG. 4, in contrast with the examples shown in FIG. 3, methods of the present disclosures discuss automatically updating assistance data of an indoor navigation system library using a feedback approach involving multiple communications with mobile devices or other surveyor devices. Flowchart 400 describes an example process according to some embodiments. Starting at block 410, an AD server may generate the initial assistance data. This process may include extracting features, such as walls and doors, from a blueprint or map of a floor or building. From here, a server or system may utilize the AD library in a normal mode of operation, at block 450, if no AD updates are necessary.

In other cases, the AD update process proceeds at block 420. In some cases, the AD library may periodically enter a calibration mode of operation in order to update the AD. In other cases, an AD update may be initiated based on some predetermined threshold, such as comparing estimated locations using the current AD with actual locations of a mobile device based on independently determined methods, e.g. GNSS positioning techniques.

At block 430, a server of an indoor navigation system may request time calibration factor (TCF) measurements from a mobile device. Generally, a TCF measurement refers to the turn-around time of an AP between reception of a packet at a receiving device and retransmission of a response packet from the receiving device. In some embodiments, other ranging measurements may be requested, such as RTT measurements. The mobile device interacting with the indoor navigation system may possess a known ground truth (GT), which may be used to compare against estimated locations using the existing AD. Because the mobile device may be relied upon to have a known GT, these mobile devices may be referred to herein as reference positioning terminals. In other cases, APs with known GT may serve as a reference positioning terminal. For example, some APs within the same indoor navigation system may be known to have not moved, based on information about the location of said AP or other apparent reasons, e.g., an AP is known to be affixed to a load-bearing column in the building, so it can be reasoned that said AP either has not moved or the building would be collapsing. As another example, APs that are determined to be producing location estimates consistent with known ground truths may be reasoned to be accurate and reliable.

At block 440, the indoor navigation system may compute parameters such as optimum transmission (TX) gain, received signal strength indicator (RSSI) threshold, and other metrics that may be useful for quantifying the signal strength qualities at various locations in the venue. In some embodiments, the position computed by the Library in normal operation in block 450 may be a function of the AD and various position engine parameters, e.g. parameters in block 440. The parameters in block 440 may be parameters more relevant to the position engine itself rather than be used to generate or facilitate the generation of the assistance data. The various parameters in block 440 may be tuned based on the quality of the measurements, device characteristics, and/or topology of the AP deployments that may be used to tune the position engine.

At block 470, a determination may be made whether the assistance data may need to be updated. For example, if one or more requested TCF measurements from block 430 produces timing results that render the estimated location of the reference positioning terminal to be sufficiently different than the ground truth location, then it may be determined that the AD needs to be updated. For example, if the difference between the estimated location and the ground truth location is greater than 5 meters, then it may be determined that the AD needs to be updated. One of ordinary skill in the art will understand that other threshold distances may be used, and embodiments are not so limited.

At block 460, the AD may be updated with the TCF measurements obtained at block 430. In some embodiments, an access point may send a server associated with an indoor navigation system an assistance data update and ranging measurements of a reference positioning terminal. Upon receiving the assistance data update, the server may update the assistance data using the ranging measurements of the reference positioning terminal. In some embodiments, the access point may perform the assistance data update. Other types of AD may be updated and requested at block 460 in the flowchart 400, or in earlier blocks in flowchart 400. For example, the AD may include signal strength information, RTT information, probability information (e.g. if a wall is detected, the location of the wall is updated to have zero probability that a mobile device is located there), connectivity information (e.g. node to node connectivity), and LOS information.

At block 450, once the AD has been updated, the indoor navigation library may operate normally and may utilize the updated library with the updated AD.

It is noted that this feedback process may not require any manual input from a user or surveyor. For example, a reference positioning terminal of a user, e.g. a mobile device, may interact with the indoor navigation system to perform this feedback process using an application running passively that does not require the user to activate it. The user simply needs to walk in range of at least one of the APs of the indoor navigation system, at which point the application on the mobile device may start automatically running.

In some embodiments, these aforementioned techniques may be crowd-sourced using multiple reference positioning terminals, e.g. multiple APs and/or multiple users/customers, to generate a more robust set of AD. In some embodiments, updating AD may involve only a local portion of the AD whose data needs to be updated based on the changes to the building layout. This may be advantageous over existing methods, which tend to regenerate the entire set of AD whenever the AD is manually updated. It is possible for only a localized portion of the AD to be updated due to the feedback and threshold characteristics of the present disclosures.

In some embodiments, multiple sets of AD may be provided to the reference terminals during the AD updating process. For example, client devices that support multiple frequencies (e.g. 2.4 and 5 GHz) may receive AD associated with each frequency. Since the signals at each frequency may behave differently as they travel through walls and other materials, having multiple sets therefore allows for even more accurate positioning, as the same location of the mobile device can be in a sense corroborated using the different sets of AD. In some embodiments, AD information may be sent to multiple antennas of a reference terminal, assuming such capacity exists.

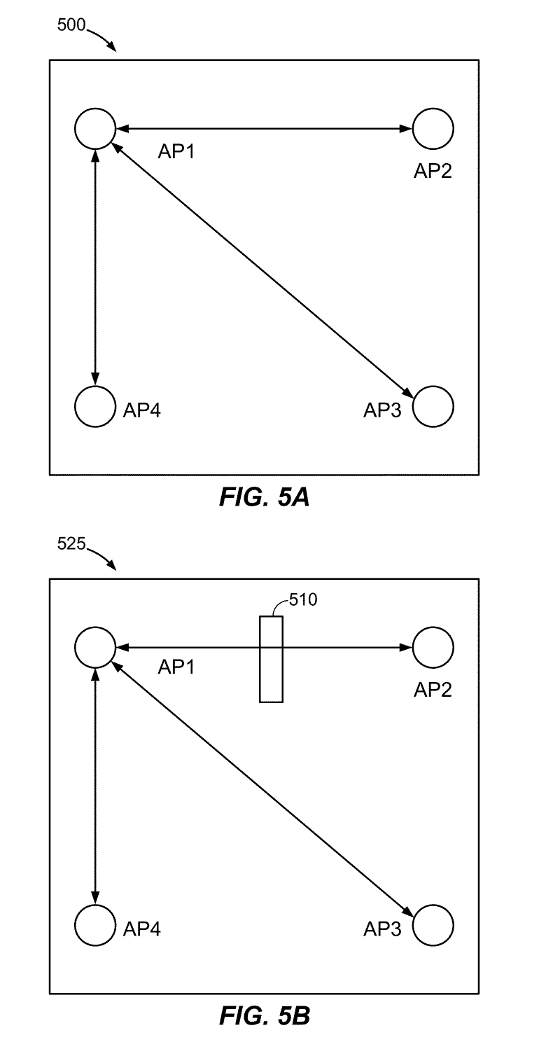

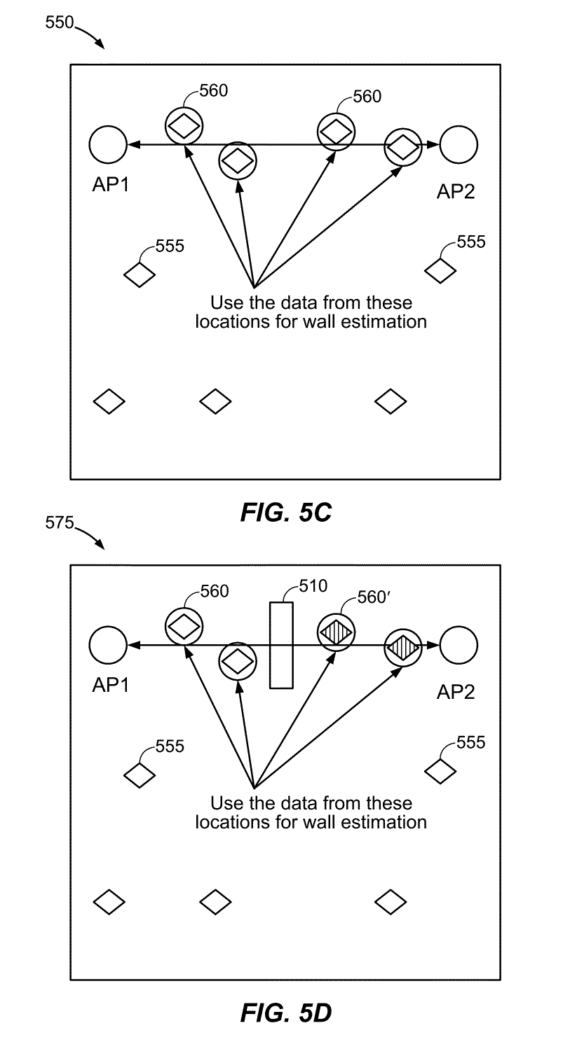

Referring to FIGS. 5A and 5B, a simple example scenario is illustrated, utilizing the steps discussed in FIG. 4. At illustration 500, initial ranging measurements from each AP (e.g. AP1, AP2, AP3, AP4) to each other AP are requested and recorded, for a total of six ranging measurements (e.g., {AP1, AP2}, {AP1, AP3}, {AP1, AP4}, {AP2, AP3}, {AP2, AP4}, and {AP3, AP4}, since {APX, APY} is assumed to be an equivalent ranging measurement to {APY, APX}). Based on the totality of these ranging measurements, each of the locations of the APs may be determined relative to each other.

Referring to FIG. 5B at illustration 525, a wall or divider 510 may be placed in between AP1 and AP2, as shown. As a result of the wall or divider 510, AP1 and AP2 may experience a greater signal drop with respect to signals received from each other, while they each should receive no change in the signal characteristics from either AP3 or AP4. It should be noted that in this example, each of the APs are being treated as the reference positioning terminals, though in other examples, mobile devices of customers or visitors can also be used. In some embodiments, the signal drop between AP1 and AP2 may surpass some predetermined threshold, such that the AD of the APs may need to be updated. Since only the signal characteristics between AP1 and AP2 have changed, it can be reasoned that the only change has occurred between AP1 and AP2, and the AD can be updated accordingly. As mentioned above, only a portion of the AD, i.e. the AD relevant to AP1 and AP2, need be updated, rather than the entire set encompassing AP3 and AP4 as well. This may be advantageous over other methods that need to update the entire set of AD or at least large portions for any particular update.

Referring to FIGS. 5C and 5D, an example scenario for estimating a location of a wall and updating the AD accordingly is illustrated. At illustration 550, only AP1 and AP2 are shown, for clarity purposes. Here, a ground truth enabled device, such as a device with GPS capabilities or other independent location sensors, may take measurements throughout the floor at certain regular intervals, such as once a week, once a month, twice a year, or the like. The measurements may be indicated by the measurement 555 and measurement 560, for example. In some embodiments, crowdsourcing may be used and multiple measurements may be taken from multiple devices, rather than have just a single device periodically sample measurements from around the venue. Measurements recorded between a more direct path between AP1 and AP2, such as measurements 560, may be used principally for wall location estimation between AP1 and AP2.

Referring to illustration 575 in FIG. 5D, wall 510 has been installed between AP1 and AP2. Thus, measurements to AP1 may show reduced signal strength when on the side of wall 510 nearer to AP2, such as measurement 560′. Measurement 560′ may be compared to the historical signal strength measurement at its same location but before the existence of wall 510, e.g. measurements previously in illustration 550. Similarly, measurements on the side of wall 510 nearer to AP1 may not have a change in signal strength to AP1, and thus it can be determined that a wall has not been installed on that side.

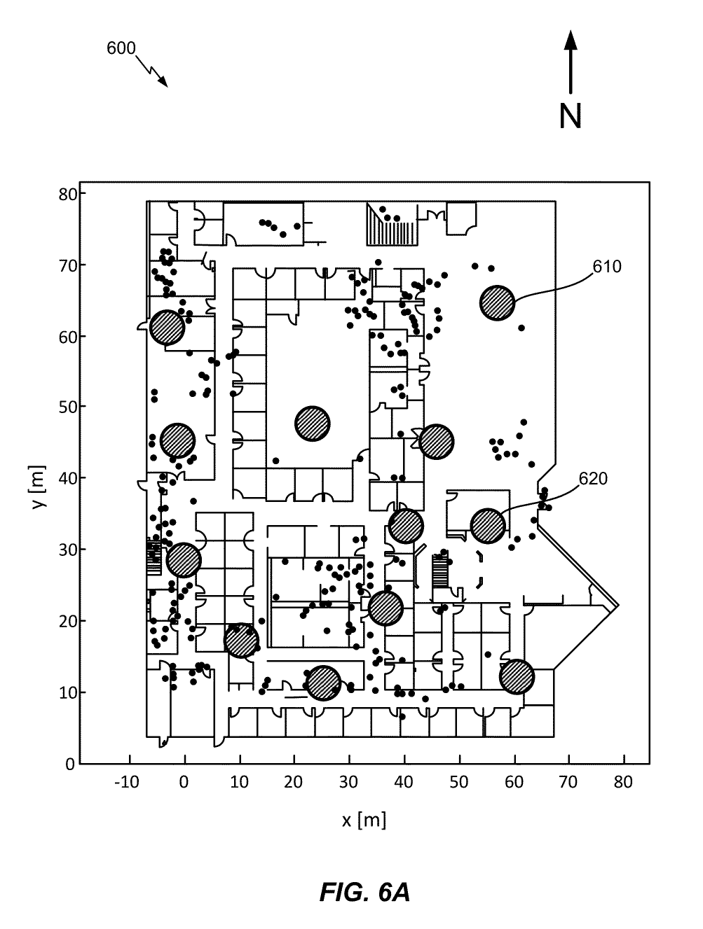

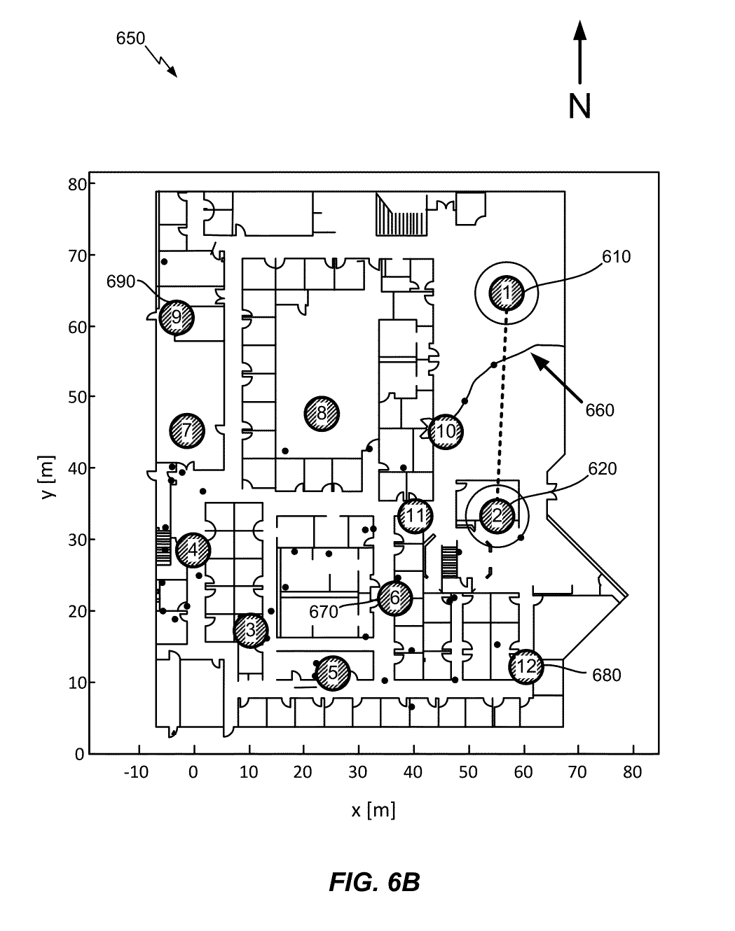

Referring to FIG. 6A, illustration 600 shows another example utilizing the techniques described in the present disclosures. Here, an example overhead floor plan layout of a building is shown with various APs, depicted as circles, e.g. APs 610 and 620, etc. Example scales in the x and y direction are shown in meters (m). The building may be any type of building, such as a museum, an office building, a hotel, or the like. Ranging measurements between each of the APs may be recorded in an initial phase. Additionally, mobile devices of various patrons, customers, or consumers in the building may interact with the various APs to further calibrate and refine the assistance data of indoor navigation system associated with the APs.

Referring to FIG. 6B, illustration 650 shows the same overhead layout of the building, but with an additional wall or divider installed, as shown with arrow 660. If this were a museum for example, the wall or divider may represent the partition of a new exhibit or two. If this were a hotel for example, the wall or divider may allow for a new restaurant and the divider may partition the larger space between the restaurant and a walkway around it. Regardless, the divider now presents an impediment between APs 610 and 620, while the APs to the west and south of AP 620 should experience no change in signal in relation to AP 620. Additionally, the wall may also cause a change in signal strength and other characteristics between AP 610 and other APs, for example possibly APs 670 and 680. On the other hand, there should be no change in signal strength between AP 610 and 690, for example. Combining all of this information and other similar analysis between different reference positioning terminals, it is possible to identify the nature and location of where the new divider has been installed, without ever requiring a manual modification to the assistance data by any human analyst.

It is noted that, while it can be deduced that a new wall has been installed between AP 610 and AP 620, it may not be immediately and unambiguously determined where exactly the wall is located within the span between AP 610 and AP 620. However, multiple measurements obtained from other sources in and around the space between APs 610 and 620, e.g. using measurements from mobile devices via crowdsourcing, can ultimately determine the nature and location of the wall. For example, if mobile devices north of the wall, e.g. around x=55 m, y=60 m, interact with AP 610, the signal measurements should not be changed from before when the new wall was not present. In contrast, if mobile devices south of the new wall, e.g., around x=55 m, y=50 m, interact with AP 610, a drop in signal strength should be expected. In general, it can ultimately be determined what side of the new wall a reference positioning terminal is located at, and thus ultimately, the exact contours of the wall can be determined with enough crowdsourcing.

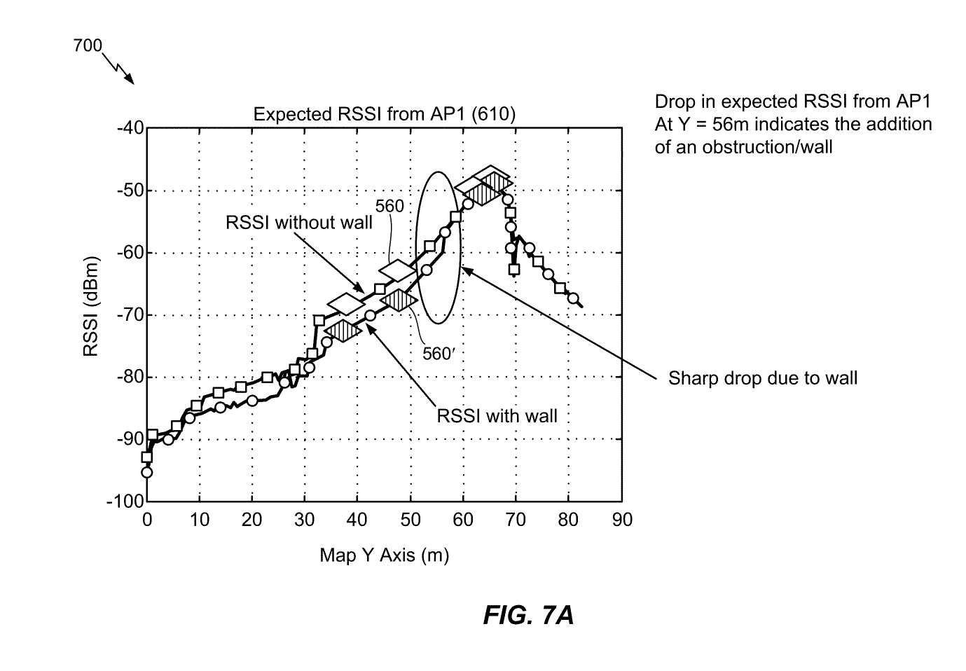

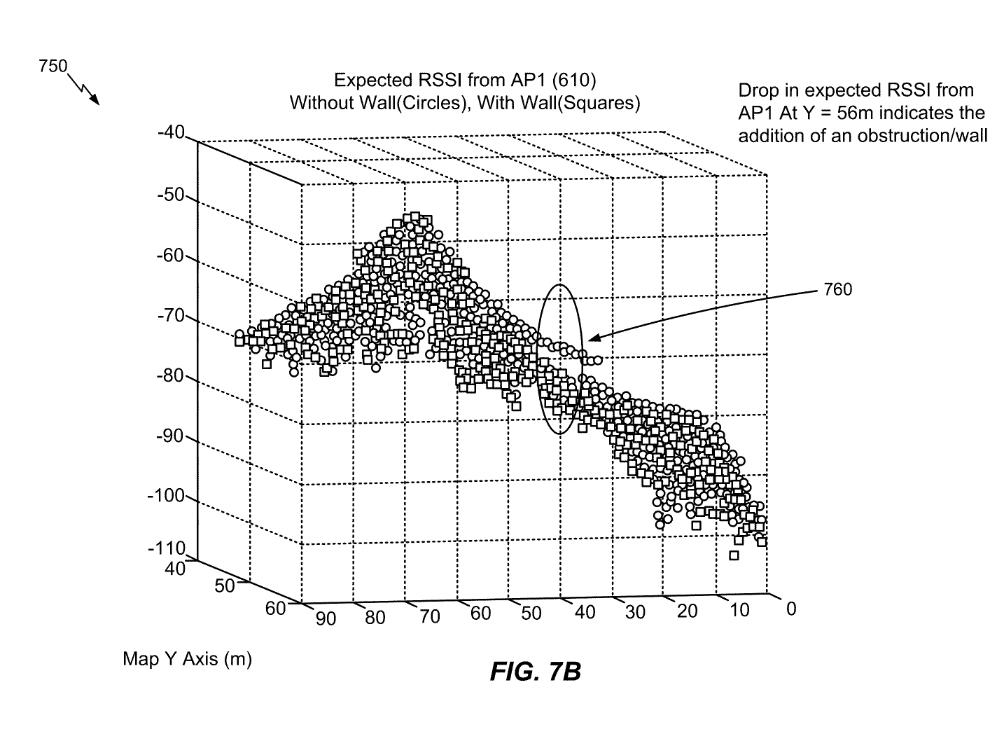

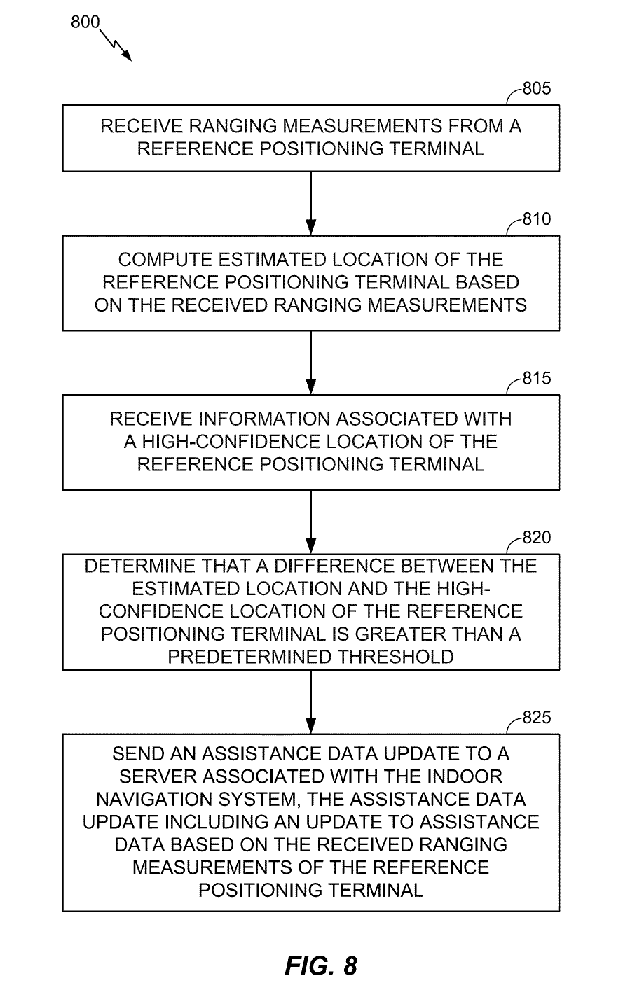

Referring to FIG. 7A, graph 700 illustrates an example plot of signal measurements that may be generated using many readings from multiple mobile devices. The graph 700 may correspond to the example in FIGS. 5C and 5D, and 6A and 6B, for clarity. In this case, the signal measurements are expressed as RSSI measurements, but other types of signal measurements known in the art may be used. One can see a clear difference in the RSSI measurements at various distances away from AP 1 (610) between when the wall is present and when the wall was not present. However, at around a y-axis distance of 56 m and higher, the RSSI measurements between when the wall is present and when it was not are now the same. This result is not surprising, since in FIG. 6B, the wall appears to be placed at around a y-axis distance of 56 meters. Thus, all signals north of y=56 m should show RSSI measurements to AP 1 (610) to be exactly the same. In other words, with enough data points of signal strength information, like what is shown in graph 700, it can be determined where exactly a new wall or divider has been placed, and the assistance data can be updated accordingly, as described above. The measurements in graph 700, e.g. measurement 560 and measurement 560′, illustrate just a few exemplary data points along the two superimposed measurement plots. As an illustration, measurement 560′ shows a substantially weaker RSSI measurement than measurement 560 when taken at the same location, indicating a likely impediment has been newly installed, e.g., the sharp drop may be due to the presence of a new wall.

It should also be noted that while gathering such comprehensive data to generate a plot like graph 700 may take some time, the AD pertaining to the affected APs can be updated as quickly as new information is obtained, either from other APs or from each new data point obtained from crowd-sourced mobile devices. That is, the AD for the indoor navigation system can be updated and utilized long before the exact location of the wall may be determined.

Referring to FIG. 7B, a 3-dimensional plot 750 illustrates another expression of the signal strength data before and after the inclusion of the new wall in FIG. 6B. The three dimensions may include the horizontal axis (e.g. east-west distance), the vertical axis (e.g. north-south distance), and signal strength attenuation. One feature to notice is the clear discrepancy in signal strength measurements highlighted by circle 760. The upper region represents the signal strength before the wall was installed, while the lower regions represent the signal strength after the wall was installed. Thus, through gathering data over time, it is possible to determine an exact location of the changes of the walls or other structures.

Referring to FIG. 8, flowchart 800 illustrates an example series of method steps for updating assistance data in an indoor navigation system. The methods described herein may be implemented by various means, including the example apparatuses, systems and processors described in any of FIGS. 1, 2, 3, 4, 5A, 5B, 5C, 5D, 6A, 6B, 7A, and 7B. For example, the method of flowchart 800 may be implemented by an access point or a server (e.g., a location server, a map server, or the like) of an indoor navigation system.

At block 805, a method may include receiving ranging measurements from a reference positioning terminal. In some embodiments, the ranging measurements may be received by an access point. In some embodiments, the ranging measurements may be received at one or more access points of an indoor navigation system, and a server of the indoor navigation system may then receive said ranging measurements from the one or more APs. The ranging measurements may include signal strength measurements, or more specifically RSSI and/or RTT measurements as examples. In some embodiments, the reference positioning terminal may include a mobile device with the capability of obtaining a ground truth of its location independent of the indoor navigation system. In some embodiments, the reference positioning terminal may include another AP in the indoor navigation system whose location is known to have not changed. In some embodiments, multiple reference positioning terminals may be used, but for purposes of clarity just one is discussed herein, and it may be readily apparent to persons of skill in the art to apply these same techniques for multiple reference positioning terminals.

At block 810, the access point or server may compute an estimated location of the reference positioning terminal based on the received ranging measurements. The estimated location may take into account the existing assistance data, meaning adjustments for known structures and other impediments may already be accounted for. Computing the estimated location may involve utilizing known positioning techniques, e.g. indoor navigation trilateration and so forth.

At block 815, the access point or server may receive information associated with a high-confidence location of the reference positioning terminal. The high-confidence location of the reference positioning terminal may be computed or determined using methods separate from how the estimated location was computed. For example, GNSS positioning techniques of a mobile device may be used to determine the high-confidence location of a mobile device. In other cases, if the reference positioning terminal is another AP of the indoor navigation system, said AP may also use GNSS positioning techniques, may reference an accurate, prerecorded location of itself, and/or may compute its location based on received indoor ranging measurements from other APs with known and reliable locations. This location may be referred to as a high-confidence location because the techniques used to determine said location of the reference positioning terminal are known to be reliable, in that there is high-confidence that the computed location is accurate to within some predetermined threshold. In contrast, the location in block 810 may be referred to as an estimated location because it is not known if additional data, such as changes in assistance data, need to be accounted while using the indoor positioning techniques to compute said location. In some embodiments, the high-confidence location corresponds to a known ground truth location of the reference positioning terminal, meaning that the high-confidence location represents the actual location of the reference positioning terminal. The information associated with the high-confidence location in block 815 may include a 2-dimensional or 3-dimensional expression of the high-confidence location, and/or timing or ranging measurements used to determine said high-confidence location, as some examples.

At block 820, the access point or server may determine a difference between the estimated location and the high-confidence location of the reference positioning terminal is greater than a predetermined threshold, based on the results in blocks 810 and 815. The difference may include a set of distances in 2 or 3 dimensions, and may reflect how far away the estimated location is from the high-confidence location of the reference positioning terminal. The difference may be expressed in any number of units consistent for a distance in 2 or 3 dimensions.

Block 825 of the flowchart 800 is optional, and is implemented when the method is performed by an access point. At optional block 825s, the access point may send an assistance data update to a server associated with the indoor navigation system (e.g., a location server, a map server, or the like). In some embodiments, the assistance data update includes an update to assistance data based on the received ranging measurements of the reference positioning terminal. In some embodiments, the assistance data may be updated by the server associated with the indoor navigation system using the ranging measurements received from the reference terminal. For example, the assistance data update may instruct the server to update the assistance data. In some embodiments, the assistance data may be updated before sending the assistance update data (e.g., by the access point). In such embodiments, the assistance data update may include the actual updated assistance data.

The method described in FIG. 8 may be consistent with the methods described in any of FIGS. 4, 5A, 5B, 5C, 5D, 6A, 6B, 7A, and/or 7B.

Many embodiments may be made in accordance with specific requirements. For example, customized hardware might also be used, and/or particular elements might be implemented in hardware, software (including portable software, such as applets, etc.), or both. Further, connection to other computing devices such as network input/output devices may be employed.

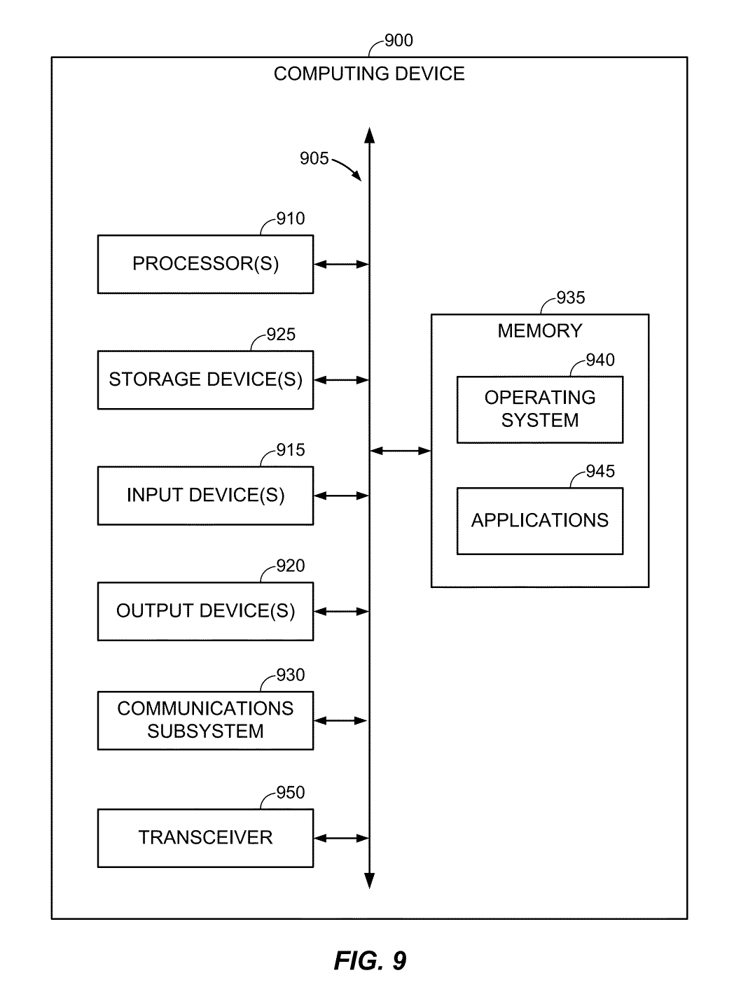

Having described multiple aspects of improving assistance data parameters in floor plan maps for indoor positioning, an example of a computing system in which various aspects of the disclosure may be implemented will now be described with respect to FIG. 9. According to one or more aspects, a computer system as illustrated in FIG. 9 may be incorporated as part of a computing device, which may implement, perform, and/or execute any and/or all of the features, methods, and/or method steps described herein. For example, computer system 900 may represent some of the components of a hand-held device. A hand-held device may be any computing device with an input sensory unit, such as a wireless receiver or modem. Examples of a hand-held device include but are not limited to video game consoles, tablets, smart phones, televisions, and mobile devices or mobile stations. As another example, the computer system 900 may represent some of the components of an access point. As yet another example, the computer system 900 may represent some of the components of a location server.

In some embodiments, the computer system 900 is configured to implement any of the methods described above. FIG. 9 provides a schematic illustration of one embodiment of a computer system 900 that can perform the methods provided by various other embodiments, as described herein, and/or can function as an access point, location server, host computer system, a remote kiosk/terminal, a point-of-sale device, a mobile device, a set-top box, and/or a computer system. FIG. 9 is meant only to provide a generalized illustration of various components, any and/or all of which may be utilized as appropriate. FIG. 9, therefore, broadly illustrates how individual system elements may be implemented in a relatively separated or relatively more integrated manner.

The computer system 900 is shown comprising hardware elements that can be electrically coupled via a bus 905 (or may otherwise be in communication, as appropriate). The hardware elements may include one or more processors 910, including without limitation one or more general-purpose processors and/or one or more special-purpose processors (such as digital signal processing chips, graphics acceleration processors, and/or the like); one or more input devices 915, which can include without limitation a camera, wireless receivers, wireless sensors, a mouse, a keyboard and/or the like; and one or more output devices 920, which can include without limitation a display unit, a printer and/or the like. In some embodiments, the one or more processor 910 may be configured to perform a subset or all of the functions described above with respect to FIG. 8. The processor 910 may comprise a general processor and/or and application processor, for example. In some embodiments, the processor is integrated into an element that processes visual tracking device inputs and wireless sensor inputs.

The computer system 900 may further include (and/or be in communication with) one or more non-transitory storage devices 925, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data storage, including without limitation, various file systems, database structures, and/or the like.

The computer system 900 might also include a communications subsystem 930, which can include without limitation a modem, a network card (wireless or wired), an infrared communication device, a wireless communication device and/or chipset (such as a Bluetooth® device, an 802.11 device, a WiFi device, a WiMax device, cellular communication facilities, etc.), and/or the like. The communications subsystem 930 may permit data to be exchanged with a network (such as the network described below, to name one example), other computer systems, and/or any other devices described herein. In many embodiments, the computer system 900 will further comprise a non-transitory working memory 935, which can include a RAM or ROM device, as described above. In some embodiments, communications subsystem 930 may interface with transceiver(s) 950 configured to transmit and receive signals from access points or mobile devices. Some embodiments may include a separate receiver or receivers, and a separate transmitter or transmitters.

The computer system 900 also can comprise software elements, shown as being currently located within the working memory 935, including an operating system 940, device drivers, executable libraries, and/or other code, such as one or more application programs 945, which may comprise computer programs provided by various embodiments, and/or may be designed to implement methods, and/or configure systems, provided by other embodiments, as described herein. Merely by way of example, one or more procedures described with respect to the method(s) discussed above, for example as described with respect to FIG. 9, might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 925 described above. In some cases, the storage medium might be incorporated within a computer system, such as computer system 900. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 900 and/or might take the form of source and/or installable code, which, upon compilation and/or installation on the computer system 900 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

Some embodiments may employ a computer system (such as the computer system 900) to perform methods in accordance with the disclosure. For example, some or all of the procedures of the described methods may be performed by the computer system 900 in response to processor 910 executing one or more sequences of one or more instructions (which might be incorporated into the operating system 940 and/or other code, such as an application program 945) contained in the working memory 935. Such instructions may be read into the working memory 935 from another computer-readable medium, such as one or more of the storage device(s) 925. Merely by way of example, execution of the sequences of instructions contained in the working memory 935 might cause the processor(s) 910 to perform one or more procedures of the methods described herein, for example methods described with respect to FIGS. 4, 5A, 5B, 5C, 5D, 6A, 6B, 7A, 7B, and 8.

The terms “machine-readable medium” and “computer-readable medium,” as used herein, refer to any medium that participates in providing data that causes a machine to operate in a specific fashion. In an embodiment implemented using the computer system 900, various computer-readable media might be involved in providing instructions/code to processor(s) 910 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 925. Volatile media include, without limitation, dynamic memory, such as the working memory 935. Transmission media include, without limitation, coaxial cables, copper wire and fiber optics, including the wires that comprise the bus 905, as well as the various components of the communications subsystem 930 (and/or the media by which the communications subsystem 930 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 910 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 900. These signals, which might be in the form of electromagnetic signals, acoustic signals, optical signals and/or the like, are all examples of carrier waves on which instructions can be encoded, in accordance with various embodiments of the invention.

The communications subsystem 930 (and/or components thereof) generally will receive the signals, and the bus 905 then might carry the signals (and/or the data, instructions, etc. carried by the signals) to the working memory 935, from which the processor(s) 910 retrieves and executes the instructions. The instructions received by the working memory 935 may optionally be stored on a non-transitory storage device 925 either before or after execution by the processor(s) 910. Working memory 935 may contain at least one database according to any of the databases and methods described herein. Working memory 935 may thus store any of the values discussed in any of the present disclosures, including FIGS. 1, 2, 3, 4, 5A, 5B, 5C, 5D, 6A, 6B, 7A, 7B, 8 and related descriptions.

The methods described in FIGS. 4, 5A, 5B, 5C, 5D, 6A, 6B, 7A, 7B, and 8 may be implemented by various blocks in FIG. 9. For example, processor 910 may be configured to perform any of the functions of blocks in flowchart 800. Storage device 925 may be configured to store an intermediate result, such as a globally unique attribute or locally unique attribute discussed within any of blocks mentioned herein. Storage device 925 may also contain a database consistent with any of the present disclosures. The working memory 935 may similarly be configured to record signals, representation of signals, or database values necessary to perform any of the functions described in any of the blocks mentioned herein. Results that may need to be stored in a temporary or volatile memory, such as RAM, may also be included in working memory 935, and may include any intermediate result similar to what may be stored in storage device 925. Input device 915 may be configured to receive wireless signals from satellites and/or base stations according to the present disclosures described herein. Output device 920 may be configured to display images, print text, transmit signals and/or output other data according to any of the present disclosures.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, some embodiments were described as processes depicted as flow diagrams or block diagrams. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

Having described several embodiments, various modifications, alternative constructions, and equivalents may be used without departing from the spirit of the disclosure. For example, the above elements may merely be a component of a larger system, wherein other rules may take precedence over or otherwise modify the application of the invention. Also, a number of steps may be undertaken before, during, or after the above elements are considered. Accordingly, the above description does not limit the scope of the disclosure.

The techniques described herein may be used for mobile device or client access to various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), CDMA2000, etc. UTRA includes Wideband-CDMA (W-CDMA) and Low Chip Rate (LCR). CDMA2000 covers IS-2000, IS-95, IS-856 and High Rate Packet Data (HRPD) standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA is part of Universal Mobile Telecommunication System (UMTS). Long Term Evolution (LTE) is a radio access technology used by E-UTRA. UTRA, E-UTRA, GSM, UMTS and LTE are described in documents from an organization named “3rd Generation Partnership Project” (3GPP). CDMA2000 is described in documents from an organization named “3rd Generation Partnership Project 2” (3GPP2). IEEE 802.11 networks are also known as WiFi networks or wireless local area networks (WLANs) and are defined in a family of standards from the Institute of Electrical and Electronics Engineers (IEEE). These various radio technologies and standards are known in the art.

Various examples have been described. These and other examples are within the scope of the following claims.

What is claimed is:

1. A method for updating assistance data in an indoor navigation system, the method comprising:
receiving ranging measurements from a reference positioning terminal;
computing an estimated location of the reference positioning terminal based on the received ranging measurements;
receiving information associated with a high-confidence location of the reference positioning terminal;
determining that a difference between the estimated location and the high-confidence location of the reference positioning terminal is greater than a predetermined threshold; and
sending an assistance data update to a server associated with the indoor navigation system, the assistance data update including an update to assistance data based on the received ranging measurements of the reference positioning terminal.

2. The method of claim 1, wherein the ranging measurements comprise RSSI and/or RTT measurements.

3. The method of claim 1, wherein the reference positioning terminal comprises a mobile device with a known ground truth.

4. The method of claim 1, wherein the ranging measurements are received at a first access point associated with the indoor navigation system.

5. The method of claim 4, wherein the reference positioning terminal comprises a second access point associated with the indoor navigation system.

6. The method of claim 4, wherein the assistance data update includes an update to a localized portion of the assistance data associated with the first access point.

7. The method of claim 1, wherein the assistance data comprises locations of access points, information associated with a physical layout of a building, and heatmap data associated with timing information of the access points.

8. The method of claim 1, wherein the information associated with the high-confidence location comprises information associated with a location of the reference positioning terminal.

9. An access point, comprising:
a wireless transceiver configured to:
receive ranging measurements from a reference positioning terminal; and
receive information associated with a high-confidence location of the reference positioning terminal; and
a processor configured to:
compute an estimated location of the reference positioning terminal based on the received ranging measurements; and
determine that a difference between the estimated location and the high-confidence location of the reference positioning terminal is greater than a predetermined threshold; and
wherein the wireless transceiver is configured to send an assistance data update to a server associated with an indoor navigation system, the assistance data update including an update to assistance data based on the received ranging measurements of the reference positioning terminal.

10. The access point of claim 9, wherein the ranging measurements comprise RSSI and/or RTT measurements.

11. The access point of claim 9, wherein the reference positioning terminal comprises a mobile device with a known ground truth.

12. The access point of claim 9, wherein the reference positioning terminal comprises an additional access point associated with the indoor navigation system.

13. The access point of claim 9, wherein the assistance data update includes an update to a localized portion of the assistance data associated with the access point.

14. The access point of claim 9, wherein the assistance data comprises locations of access points, information associated with a physical layout of a building, and heatmap data associated with timing information of the access points.

15. The access point of claim 9, wherein the information associated with the high-confidence location comprises information associated with a location of the reference positioning terminal.

16. A system for updating assistance data in an indoor navigation system, comprising:
means for receiving ranging measurements from a reference positioning terminal;
means for computing an estimated location of the reference positioning terminal based on the received ranging measurements;
means for receiving information associated with a high-confidence location of the reference positioning terminal;
means for determining that a difference between the estimated location and the high-confidence location of the reference positioning terminal is greater than a predetermined threshold; and
means for sending an assistance data update to a server associated with the indoor navigation system, the assistance data update including an update to the assistance data based on the received ranging measurements.

17. The system of claim 16, wherein the ranging measurements comprise RSSI and/or RTT measurements.

18. The system of claim 16, wherein the reference positioning terminal comprises a mobile device with a known ground truth.

19. The system of claim 16, wherein the reference positioning terminal comprises an access point associated with the system.

20. The system of claim 16, wherein the assistance data update includes an update to a localized portion of the system associated with an access point.

21. The system of claim 16, wherein the assistance data comprises locations of access points, information associated with a physical layout of a building, and heatmap data associated with timing information of the access points.

22. The system of claim 16, wherein the information associated with the high-confidence location comprises information associated with a location of the reference positioning terminal.

23. A non-transitory processor-readable medium comprising processor-readable instructions configured to cause a processor to update assistance data in an indoor navigation system, comprising:
code to receive ranging measurements from a reference positioning terminal;
code to receive information associated with a high-confidence location of the reference positioning terminal;
code to compute an estimated location of the reference positioning terminal based on the received ranging measurements;
code to determine that a difference between the estimated location and the high-confidence location of the reference positioning terminal is greater than a predetermined threshold; and
code to send an assistance data update to a server associated with the indoor navigation system, the assistance data update including an update to the assistance data based on the received ranging measurements of the reference positioning terminal.

24. The processor-readable medium of claim 23, wherein the assistance data comprises locations of access points, information associated with a physical layout of a building, and heatmap data associated with timing information of the access points.
